(19) United States
(12) Patent Application Publication
(10) Pub. No.: US 2025/0320579 A1
(43) Pub. Date: Oct. 16, 2025

(54) METHOD FOR PROCESSING ROUGH COPPER CONCENTRATES FROM WASTE TAILINGS

(71) Applicants: Lyutsiya Monirovna KARIMOVA, Karaganda (KZ); Yerlan Tokpaevich KAIRALAPOV, Karaganda (KZ); Guldana Kakimovna MAKASHEVA, Karaganda (KZ); Yelena Mikhailovna KHARCHENKO, Temirtau (KZ); Bauyrzhan Boranbaevich KATRENOV, Temirtau (KZ)

(72) Inventors: Lyutsiya Monirovna KARIMOVA, Karaganda (KZ); Yerlan Tokpaevich KAIRALAPOV, Karaganda (KZ); Guldana Kakimovna MAKASHEVA, Karaganda (KZ); Yelena Mikhailovna KHARCHENKO, Temirtau (KZ); Bauyrzhan Boranbaevich KATRENOV, Temirtau (KZ)

(21) Appl. No.: 18/635,092

(22) Filed: Apr. 15, 2024

(51) Int. Cl. C22B 15/00; C22B 1/16; C22B 3/08; C22B 3/42; C22B 11/00; C22B 61/00

(52) U.S. Cl. CPC C22B 15/0069; C22B 1/16; C22B 3/08; C22B 3/42; C22B 11/042; C22B 61/00

(57) ABSTRACT

The invention relates to hydrometallurgical technology, in particular, to methods for extracting metals from waste copper tailings and concentrates. The objective of the invention is to increase the degree of desiliconization of concentrates while simultaneously lowering the heat treatment temperature and comprehensive extraction of valuable components. The achieved technical result of the proposed invention is the sequence of technological operations, the sintering condition with sodium hydroxide and the sequence of extraction of silica, rhenium, copper and silver from solution. The technical result is achieved by desiliconization at normal pressure in an air atmosphere by sintering with the most active reagent-sodium hydroxide and further selective extraction of silica and rhenium during aqueous leaching, copper and silver during sulfuric acid leaching with the extraction of copper from the solution by extraction, and silver by sorption.

### GOVERNMENT INTEREST

The work was carried out under grant project AR 19675340, funded by the Science Committee of the Ministry of Education and Science of the Republic of Kazakhstan.

### FIELD OF THE INVENTION

The present disclosure relates to hydrometallurgical technology, in particular, to a hydrometallurgical processing method for extracting metals and other valuable components from waste tailings and concentrates.

### BACKGROUND

One of the areas of hydrometallurgical processing of sulfide mineral rough materials containing non-ferrous, rare and noble metals is the desiliconization of the rough concentrate at low temperatures with further leaching at atmospheric pressure. This complex processing, which includes flotation and chemical enrichment, results in an interdependent recovery of metals and other valuable components (e.g., SiO₂, Re, Cu, Ag,).

The method involves sintering the concentrate with sodium hydroxide. Next, the solid sintering residue is leached, first with water, then with a solution of sulfuric acid, followed by the production of commercial products: white soot, ammonium perrhenate, copper cathode and metallic silver.

The prior art discloses a method for desiliconizing iron-containing concentrates by fusing them with soda ash at a temperature of 700-850° C. to form Na₂SiO₃. The resulting alloy is treated with water or acid. The degree of desiliconization of concentrates by this method is 88-94%. The disadvantage of this method is the high fusion temperatures of the rough concentrate (more than 700° C.).

The prior art also discloses a method for autoclave desiliconization of off-balance sheet copper sulfide ore of the Konyrat deposit (Balkhash, Karaganda Region, Kazakhstan) with the following composition in mass. %: Cu—0.32, SiO₂—68.35, Al₂O₃—10.88, Fe—3.1, S—2.35, Re—0.0001 (1.0 g/t). After flotation enrichment of the original ore, the concentrate of the following composition in wt. % is obtained: Cu—4.86, SiO₂—33.9, Al₂O₃—18.18, Fe—8.75, S—2.64. The flotation scheme includes ore grinding to 70-75% class −0.071 mm, main and control flotation. In order to reduce the concentration of SiO2, the concentrate is subjected to alkaline autoclave desiliconization with an alkali concentration (160 g/l) and a L:S ratio=5:1, temperature 230° C. The disadvantage of this method are as follows: the low degree of desiliconization of concentrates (57.10% SiO₂), as well as the lack of the possibility to extract other non-ferrous metals, such as silver, rhenium.

The prior art also discloses a method for processing titanium-silicon-containing concentrates to produce artificial rutile, and a method for processing high-clay potassium ores to produce rough anhydrous sylvite concentrate. However, these methods use a sintering process and a one-step leaching process to produce a single product of rutile or potassium chloride, respectively).

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution to increase the degree of desiliconization of rough concentrates of waste tailings, while simultaneously reducing their heat treatment or sintering temperature and providing a comprehensive extraction of valuable components therefrom.

The objective above is achieved by the features of the independent claim in the appended claims. Further embodiments and examples are apparent from the dependent claims, the detailed description, and the accompanying drawings.

More specifically, a hydrometallurgical processing method is provided, which is performed as follows. At first, a rough concentrate of waste tailings is obtained or provided, which contains silica, copper, silver, and rhenium. Then, the rough concentrate is sintered with sodium hydroxide at a temperature of 300 to 320° C., thereby obtaining a solid sintering residue. Next, a first pulp is obtained by subjecting the solid sintering residue to aqueous leaching. The first pulp is then subjected to filtering to obtain a first cake and a first filtrate. The first filtrate is a solution that contains the silica and the rhenium. Further, the silica and the rhenium are recovered from the first filtrate. As for the first cake, it is subjected to sulfuric acid leaching with an addition of halite, resulting in obtaining a second pulp. After that, the second pulp is subjected to filtering to obtain a second cake and a second filtrate. The second filtrate is a solution that contains the copper and the silver. Subsequently, the copper and the silver are recovered from the second filtrate.

Thus, unlike the above-mentioned prior art analogues which typically focus on using one-step leaching processes or producing a single product, the present method involves complex processing of rough concentrates of waste tailings, including the sintering and two-step leaching steps to selectively recover commercially valuable components, such as silica, copper, silver, and rhenium. More specifically, silicon or silica and rhenium are obtained after said aqueous leaching, as well as copper and silver are obtained after said sulfuric acid leaching with the addition of halite.

Furthermore, the present method requires lower temperatures (300-320° C.) compared to the above-mentioned prior art analogues which often require much higher sintering temperatures (e.g., over 700° C.). This lower temperature requirement reduces energy consumption and operational costs, while maintaining efficient desiliconization and metal extraction.

On top of that, the present method involves the oxidation of sulfide minerals typically contained in the rough concentrates during the sintering process, which simplifies subsequent leaching steps. This oxidation facilitates the conversion of the sulfides into oxides, making the leaching of copper and silver from the rough concentrate more straightforward without the need for additional oxidative treatments.

In one exemplary embodiment, the rough concentrate is subjected to said sintering with sodium hydroxide with an addition of sodium nitrite (NaNO₂). Sodium nitrite may improve (accelerate) the oxidation of the sulfides.

In one exemplary embodiment, said aqueous leaching is performed at a temperature of 60° C. with a liquid-to-solid (L:S) ratio of 3:1 for a duration of 60 minutes. By using these parameter values, said aqueous leaching may be performed more efficiently.

In one exemplary embodiment, said sulfuric acid leaching is performed at a temperature of 80-90° C. with a sulfuric acid solution concentration of 80 g/l and a L:S ratio of 4:1 for 180 minutes. By using these parameter values, said sulfuric acid leaching may be performed more efficiently.

In one exemplary embodiment, the silver recovery is performed as follows. At first, ion exchange resin capable of sorbing silver is added to the second filtrate. Then, a silver-containing desorbate is obtained by adding the ion exchange resin with the sorbed silver to a thiourea sulfate solution. After that, the silver-containing desorbate is subjected to electrolytic deposition. This approach allows for efficient recovery of silver with high purity, suitable for commercial applications.

In one exemplary embodiment, silica and rhenium are recovered as follows. At first, silica is recovered as white soot by adding carbon dioxide to the first filtrate. Then, a rhenium-containing solution is obtained by removing the white soot from the first filtrate. Next, the rhenium-containing solution is added to an absorption column comprising an anion exchange resin that is able to sorb rhenium (e.g., Purolite A170). After that, the rhenium recovery as ammonium perrhenate is performed by adding the anion exchange resin with the sorbed rhenium to a desorption column and feeding ammonia water to the desorption column. By doing so, it is possible to efficiently obtain such commercially valuable products as white soot and ammonium perrhenate.

Other features and advantages of the present disclosure will be apparent upon reading the following detailed description and reviewing the accompanying drawings.

### BRIEF DESCRIPTION OF DRAWINGS

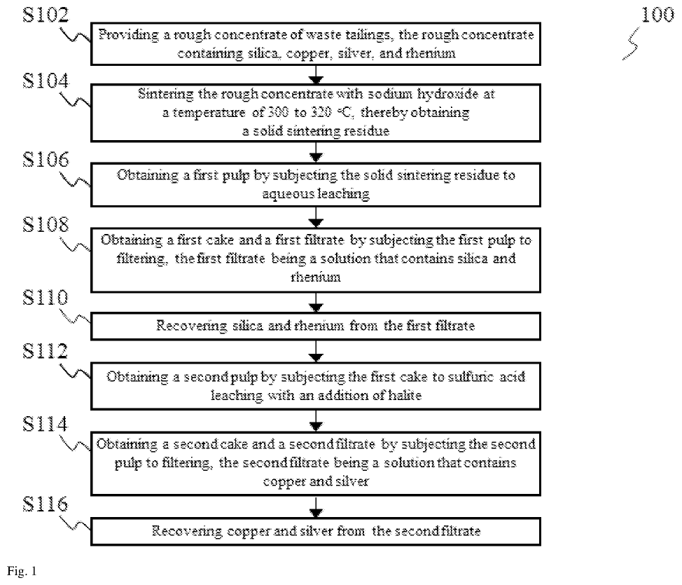

The present disclosure is explained below with reference to FIG. 1 which shows a flowchart of a hydrometallurgical processing method according to one exemplary embodiment.

### DETAILED DESCRIPTION OF THE PREFERRED EMBODIMENT

Various embodiments of the present disclosure are further described in more detail with reference to the figure. However, the present disclosure can be embodied in many other forms and should not be construed as limited to any certain step sequence discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the method disclosed herein can be implemented in practice by using any numbers of the embodiments provided herein. Furthermore, any embodiment of the present disclosure can be implemented using one or more of the elements presented in the appended claims.

As used in the exemplary embodiments disclosed herein, a rough concentrate, or ore concentrate, may refer to the product generally produced by metal ore mines and subjected to some (coarse and/or fine) grinding and ore concentration techniques. It should be known to those skilled in the art that concentration involves the separation of valuable metal-containing minerals from the other raw materials (gangue) received from the raw ore passed through a grinding mill to concentrate one or more metallic components, thereby obtaining the rough concentrate for further processing.

The exemplary embodiments disclosed herein relate to a technical solution that allows increasing the degree of desiliconization of rough concentrates of waste tailings, while simultaneously reducing their heat treatment or sintering temperature and providing a comprehensive extraction of valuable components therefrom. For this purpose, a rough concentrate is subjected to heat treatment at a temperature of 300-320° C., wherein sodium hydroxide is used as a reagent that forms a chemical compound with silicon dioxide. The resulting solid sintering residue is then subjected to aqueous leaching (also referred to as water leaching in the art), thereby obtaining a first pulp comprising a first cake (hereinafter referred to cake 1) and a first filtrate. Cake 1 is a residue formed after said aqueous leaching. The first filtrate is used for silica and rhenium recovery, while cake 1 is subjected to another sulfuric acid leaching with an addition of a halite, resulting in a second pulp comprising a second cake (hereinafter referred to as cake 2) and a second filtrate. the second filtrate is used for copper and silver recovery.

FIG. 1 shows a flowchart of a hydrometallurgical processing method 100 according to one exemplary embodiment.

The method 100 starts with a step S102, in which a rough concentrate of waste tailings is obtained or provided, which contains silica, copper, silver, and rhenium. For example, the step S102 may be performed by using any conventional concentration techniques.

Then, the method 100 proceeds to a step S104, in which the rough concentrate is sintered with sodium hydroxide at a temperature of 300 to 320° C., thereby obtaining a solid sintering residue. Said sintering of the rough concentrate at 300-320° C. is accompanied by the oxidation of copper-containing sulfide minerals typically present in the rough concentrate. The reactions that occur during the interaction of caustic alkali with the main copper minerals in the rough concentrate are as follows:

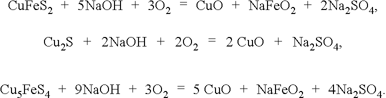

The conversion of sulfides into oxides due to atmospheric oxygen makes it possible to significantly simplify the leaching of copper and silver from the concentrate without the need for additional oxidative processes.

Preferably, the step S104 is performed with an addition of sodium nitrite (NaNO₂).

After said sintering, the method 100 goes on to a step S106, in which a first pulp is obtained by subjecting the solid sintering residue to aqueous leaching. Said aqueous leaching is a well-known process in the art, for which reason its description is omitted herein. Preferably, said aqueous leaching is performed at a temperature of 60° C. with a liquid-to-solid (L:S) ratio of 3:1 for a duration of 60 minutes.

Next, the method 100 proceeds to a step S108, in which cake 1 and a first filtrate are obtained by subjecting the first pulp to filtering. The first filtrate is a silica-and rhenium-containing. The first filtrate is then subjected to processing with the purpose of silica and rhenium recovery in a subsequent step S110.

In a preferred embodiment, the step S110 may be performed as follows. At first, silica is recovered as white soot by adding carbon dioxide to the first filtrate. Then, a rhenium-containing solution is obtained by removing the white soot from the first filtrate. Next, the rhenium-containing solution is added to an absorption column comprising an anion exchange resin that is able to sorb rhenium (e.g., Purolite A170). After that, the rhenium recovery as ammonium perrhenate is performed by adding the anion exchange resin with the sorbed rhenium to a desorption column and feeding ammonia water to the desorption column.

Cake 1 (due to the removal of “waste rock”) after said aqueous leaching and filtering is further subjected to sulfuric acid leaching in a step S112 of the method 100. Preferably, said sulfuric acid leaching is carried out in a solution of sulfuric acid 80 g/l with the addition of halite in a ratio L:S=4:1, at a temperature of 80-90° C. for a duration 180 minutes. The outcome of the step S112 is a second pulp which is subsequently subjected to filtering to obtain cake 2 and a second filtrate in a step S114 of the method 100. The second filtrate is a copper- and silver-containing solution. Said filtering may be accompanied by thickening, settling, and washing operations.

Cake 2 formed using the steps S110 and S112 is washed on a filter and sent for further processing. The wash water may be re-used in the step S106 of method 100 next time.

After the step S114, the method 100 proceeds to a step S116, in which the second filtrate is used for copper and silver recovery. Preferably, the silver recovery is performed as follows. At first, ion exchange resin capable of sorbing silver is added to the second filtrate. Then, a silver-containing desorbate is obtained by adding the ion exchange resin with the sorbed silver to a thiourea sulfate solution. After that, the silver-containing desorbate is subjected to electrolytic deposition.

The novelty and inventiveness of the method 100 are caused by the sequence of the above-indicated technological steps or operations, as well as the condition for sintering the rough concentrate, and the complex extraction of valuable components. All of this allows achieving the full processing of the rough concentrate.

### Example 1

To conduct the research, a rough concentrate was obtained from waste copper tailings (Table 1) (Ulytau region, Republic of Kazakhstan) in accordance with the method 100 shown in FIG. 1.

TABLE 1
Chemical composition of the rough concentrate sample

| | |
|---|---|
| Content of components, % | Content of components, % |

| | | | |
|---|---|---|---|
| Cu | 4.058 | Al | 5.394 |
| Fe | 15.56 | Ag, g/t | 77.03 |
| Zn | 0.151 | Si | 17.3 |
| Pb | 0.135 | Re, g/t | 3.83 |

Copper in the concentrate is represented by sulfide minerals—38.17%, oxidized—by 61.83%.

In order to convert the target components into an acid-soluble form and obtain additional commercial products, the rough concentrate was subjected to preliminary sintering with sodium hydroxide and sodium nitrite (NaNO2), followed by said aqueous leaching and said sulfuric acid leaching.

The concentrate was mixed with sodium hydroxide in a ratio of 1:2 (according to the stoichiometry of the reaction), i.e., 100 g of the concentrate and 200 g of sodium hydroxide. After that, the material under study was placed in an oven preheated to a certain temperature (which is selected from Table 2 below).

The research on sintering the concentrate with alkali was carried out at a temperature in the range of 250-500° C. The ratio of the concentrate to alkali is 1:2, 0.1% by weight of a NaNO₂ concentrate. The aqueous leaching of cake 1 was carried out at a temperature of 60° C., in a ratio L:S=3:1, and for 60 minutes. The experimental results are presented in Table 2.

TABLE 2
Chemical and phase composition of cake 1 after said aqueous leaching

| Sintering | | | | | | | Phase composition of copper | | | | |
|---|---|---|---|---|---|---|---|---|---|---|---|
| conditions | | | | | | | compounds, % | | | | |
| (sintering with | | | | | | | Oxide, | Sulf, | Ferrites, | Extraction | |
| NaOH at a ratio | Chemical analysis, % | | | | | | abs./ | abs./ | abs./ | into solution, % | |
| of 1:2) | Cu | Fe | Re | Si | Ag | Zn | rel. | rel. | rel. | Re | Si |
| t = 250° C. | 4.96 | 19.17 | 0.38 | 10.30 | 107.66 | 0.115 | 4.67/ | 0.28/ | 0.008/ | 95.82 | 84.8 |
| | | | | | | | 94.25 | 5.59 | 0.16 | | |
| t = 300° C. | 4.98 | 18.05 | 0.32 | 10.00 | 106.45 | 0.058 | 4.51/ | 0.012/ | 0.055/ | 96.48 | 85.6 |
| | | | | | | | 98.52 | 0.27 | 1.21 | | |
| t = 500° C. | 4.83 | 17.86 | 0.30 | 10.51 | 109.56 | 0.133 | 4.68/ | 0.139/ | 0.008/ | 96.50 | 86.0 |
| | | | | | | | 96.94 | 2.88 | 0.18 | | |

As can be seen from Table 2, the main part of copper in cake 1 is in oxidized form from 94.25 to 98.52%.

After said aqueous leaching, the solution contains silicate and perrhenate ions. The recovery of rhenium into the solution ranged from 95.82% to 96.50%, silicon from 84.8-86%. The solution was used to obtain commercial products (white soot and ammonium perrhenate).

To isolate white soot from a silicate solution, carbon dioxide was used as a neutralizing agent. White soot (mSiO₂·nH₂O) was obtained by the two-stage carbonization of the silicate solution (liquid glass) with carbon dioxide in a recirculation system, bringing a pH value to 9-10 within 30 minutes, and then, within 60 minutes, until the residual alkali content in the solution was 90 g/l.

The main reaction for producing white soot with carbon dioxide is as follows:

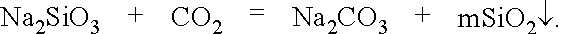

At the stage of preliminary desiliconization of the rough concentrate into solution, according to the research, up to 83% of silica and 97% of rhenium are extracted. Under optimal conditions, the silicate solution of the following composition was obtained: Na₂O=126.5 g/l, SiO₂=107.7 g/l, Al₂)₃=3.1 g/l. In a series of experiments, carbon dioxide was bubbled through the volume of the solution for a certain time determined according to the pH value (i.e., corresponding to the achievement of a pH value from the range of 9.5-9.8). The speed of the process was selected in such a way that the required final pH value (9.5-9.8) of the first pulp was achieved within a certain time period. As the duration of carbonization increases, the specific surface area decreases, which is apparently due to the predominance of the growth rate over nucleation at insufficient gas permeation volume. At high bubbling velocity, with excessive volume, a large number of crystallization centres is formed, which do not have time to grow further. Therefore, optimum time is determined to be 60-80 minutes.

White soot precipitated from the silicate solution contains a large amount of aluminum oxide (Table 3), therefore, after the carbonization, the sediment was washed with a sulfuric acid solution of 200 g/l H₂SO₄ for 60-80 minutes before drying.

TABLE 3
Chemical composition of the resulting sediment

| Component | Na₂O | MgO | Al₂O₃ | SiO₂ | CaO | Fe₂O₃ | Sum |
|---|---|---|---|---|---|---|---|
| Content | 1.96 | 0.04 | 3.16 | 94.57 | 0.06 | 0.21 | 99.70 |

Table 4 shows the results of chemical analysis of white soot after the acid treatment.

TABLE 4
Results of chemical analysis of white soot after the acid treatment

| Na₂O | MgO | Al₂O₃ | SiO₂ | CaO | Fe₂O₃ | Sum |
|---|---|---|---|---|---|---|
| 0.61 | 0.01 | 0.05 | 98.84 | 0.2 | 0.06 | 99.8 |

Next, after removing silicon, the solution is subjected to rhenium sorption.

The sorption was carried out in an absorption column on a resin with a maximum content of functional secondary amino groups Purolite A170 with a monoparticle size of 0.8 mm, selective for perrhenate ions.

The sorbent saturated with rhenium was loaded into a desorption column, where it was laid in a dense layer for sequential water washing.

A desorbing solution, ammonia water, was fed into the lower part of the desorption column and removed from its upper part in the form of an ammonia eluate saturated with rhenium, which was subjected to the stage of ammonia distillation and subsequent concentration. The regenerated sorbent was washed with water and, as necessary, returned to the rhenium sorption cycle.

The ammonia eluate saturated in rhenium was subjected to ammonia distillation.

Next, the resulting saturated solution of ammonium perrhenate was evaporated in evaporators until crystals of rough ammonium perrhenate precipitated and was subjected to filtration. The rough ammonium perrhenate was subjected to the stage of dissolution and recrystallization.

The rough ammonium perrhenate (APR) dissolves in hot water, and ammonium perrhenate recrystallizes during the cooling process. The precipitate, which is ammonium perrhenate of high purity, was filtered on a suction filter and subjected to atmospheric drying to obtain commercial ammonium perrhenate.

To extract the target components, the resulting cake (Table 2) containing: Cu—4.98%, Ag—106.45 g/t was leached with a solution of sulfuric acid with the addition of halite at a solution temperature of 90° C., in a L:S ratio=4:1, and for 180 minutes. The filtrate containing Ag—3.6 mg/l, Cu—5.9 g/l, pH—3.1 was used for the sorption of silver with an ion exchange resin of the Lewatit MonoPlus TP 214 brand produced by the Lanxess concern (Germany).

Silver in the productive solution is in the form of a chlorine-anion complex [AgCl₂]. To extract silver from the solution using the ion exchange method, it is necessary to destroy the complex by creating a more stable complex compound in the sorbent grain.

To desorb silver from this ion exchanger, it is advisable to use a thiourea sulfate solution, since in this case silver passes from the sorbent into the solution also in the form of a thiourea complex, and the functional group of the resin is restored (regeneration).

Desorption was carried out in a static mode by mixing saturated resin (10 ml) with the thiourea sulfate solution (CS(NH₂)₂) with a concentration of 70 g/l and sulfuric acid—50 g/l in a ratio L:S=10:1 for 120 minutes.

The resulting solution contained 0.402 g/l of silver. The residual silver content in the resin was 0.01%, which corresponds to a desorption degree of 99%.

After the desorption cycle, two independent material flows are formed: desorbate, which was sent to the electrolytic deposition of silver, and regenerated sorbent, freed from silver ions, which was used in further sorption cycles.

The electrolytic deposition of silver was carried out in a laboratory electrolyzer EZ-1(6/75)M using a titanium cathode, a lead anode, equipped with an MK-40L ion exchange membrane to separate the catholyte and anolyte. The catholyte was a silver-containing desorbate, and the anolyte was a sulfuric acid solution with a concentration of 20 g/l.

The main technological parameters of the electrolysis process may be selected as follows: current density—40-60 A/m2, temperature—35-40° C., solution flow rate—0.5 l/h, and voltage on the electrolysis bath—3-4.5 V, working area of the cathode and anode—0.07 m². The concentration of silver in the catholyte is 98.95 mg/l; thiourea—70 g/l; SO₄²—−48.0 g/l. The concentration of silver in the spent electrolyte was 2.4 mg/l.

The electrolyte was heated in a thermostated reactor to a temperature of 35-40° C. and, using a dosing pump, was supplied to the cathode space of the electrolysis bath. The electrolyte supply rate was calculated based on the need for complete exchange of the entire volume of the bath in 1 hour. The electrolyte, freed from silver ions, entered the waste electrolyte collection.

The spent electrolyte was saturated by using it as a desorbing solution at the silver desorption stage. During the desorption process, the electrolyte reached the specified parameters for the concentration of target components and free sulfuric acid and returned to the electrolysis cycle.

The accumulated cathode sediment of silver sulfide was unloaded with a part of the solution. Based on the data obtained during the electrolysis process, the extraction of silver from the catholyte into the cathode deposit was 97.5%.

At the end of the electrolysis process, the silver deposit accumulated under the cathode was unloaded with a part of the solution, dried, weighed and subjected to melting at a temperature of 1100° C. The resulting metal corresponds to the SrM75 grade with a silver content of 74.9%.

During the thermochemical enrichment of the rough concentrate of dump copper tailings with sodium hydroxide and subsequent aqueous and sulfuric acid leaching, the extraction of silica into the solution was 85.6%, copper—98.2%, silver—83.2%, rhenium—96.0%.

1. A hydrometallurgical processing method comprising:
providing a rough concentrate of waste tailings, the rough concentrate containing silica, copper, silver, and rhenium;
sintering the rough concentrate with sodium hydroxide at a temperature of 300 to 320° C., thereby obtaining a solid sintering residue;
obtaining a first pulp by subjecting the solid sintering residue to aqueous leaching;
obtaining a first cake and a first filtrate by subjecting the first pulp to filtering, the first filtrate being a solution that contains the silica and the rhenium;
recovering the silica and the rhenium from the first filtrate;
obtaining a second pulp by subjecting the first cake to sulfuric acid leaching with an addition of halite;
obtaining a second cake and a second filtrate by subjecting the second pulp to filtering, the second filtrate being a solution that contains the copper and the silver; and
recovering the copper and the silver from the second filtrate.

2. The method of claim 1, wherein said sintering is performed with an addition of sodium nitrite.

3. The method of claim 1, wherein said aqueous leaching is performed at a temperature of 50-60° C. with a liquid-to-solid (L:S) ratio of 3:1 for a duration of 60 minutes.

4. The method of claim 1, wherein said sulfuric acid leaching is performed at a temperature of 80-90° C. with a sulfuric acid solution concentration of 80 90 g/l and a L: S ratio of 4:1 for 170-180 minutes.

5. The method of claim 1, wherein the silver is recovered from the second filtrate by:
adding ion exchange resin to the second filtrate, the ion exchange resin being able to sorb the silver;
obtaining a silver-containing desorbate by adding the ion exchange resin with the sorbed silver to a thiourea sulfate solution; and
subjecting the silver-containing desorbate to electrolytic deposition.

6. The method of claim 1, wherein said recovering the silica and the rhenium from the first filtrate comprises:
recovering the silica as white soot by adding carbon dioxide to the first filtrate;
obtaining a rhenium-containing solution by removing the white soot from the first filtrate;
adding the rhenium-containing solution to an absorption column comprising an anion exchange resin that is able to sorb the rhenium; and
recovering the rhenium as ammonium perrhenate by adding the anion exchange resin with the sorbed rhenium to a desorption column and feeding ammonia water to the desorption column.
